(19) United States
(12) Patent Application Publication
(10) Pub. No.: US 2025/0017706 A1
(43) Pub. Date: Jan. 16, 2025

(54) HEAT TREATMENT FURNACE FOR A DENTAL RESTORATION

(71) Applicant: Ivoclar Vivadent AG, Schaan (LI)

(72) Inventors: Tarkan CETIN, Feldkirch (AT); Theresa Sujata Maria SENTI, Triesenberg (LI)

(21) Appl. No.: 18/769,303

(22) Filed: Jul. 10, 2024

(30) Foreign Application Priority Data
Jul. 12, 2023 (EP) 23185133.8

(51) Int. Cl. A61C 13/20

(52) U.S. Cl. CPC A61C 13/20; A61C 2204/00

(57) ABSTRACT

A heat treatment furnace (100) for a dental object (101), including an electronic camera (103) for generating an image data set (107) of the dental object (101) within a firing chamber (123) and an evaluation device (105) for determining a height and/or geometric dimension of the dental object (101) on the basis of the image data set (107).

### CROSS-REFERENCE TO RELATED APPLICATIONS

This application claims priority to European patent application No. 23185133.8 filed on Jul. 12, 2023, which disclosure is incorporated herein by reference in its entirety.

### TECHNICAL FIELD

The present invention relates to a heat treatment furnace for a dental object and a method for determining a height of a dental object in a heat treatment furnace.

### BACKGROUND

Up to now, the height of dental objects in dental heat treatment furnaces could only be determined when they were warm and using an infrared camera. In addition, the dental objects are limited to muffles or dental restorations.

The size of dental objects determines the working area for the infrared camera. Accordingly, information about the size of the dental objects can be of interest already when they are placed in the furnace, before they reach a certain temperature to be seen by the infrared camera. If too many dental objects are arranged in the heat treatment furnace, they will cover each other.

US20150010876 and 20140336805 are directed to dental devices and are herein incorporated by reference.

### SUMMARY

It is the technical task of the present invention to detect the height of a dental object within a heat treatment furnace.

This task is solved by subject matter according to the independent claims. Technically advantageous embodiments are the subject matter of the dependent claims, the description and the drawings.

According to a first aspect, this technical task is solved by a heat treatment furnace for a dental object, comprising an electronic camera for generating an image data set of the dental object within a firing chamber; and an evaluation device for determining a height and/or geometric dimension of the dental object on the basis of the image data set. Using the electronic image camera as an imaging sensor, it is possible to determine the height of the dental object in the heat treatment furnace independently of the heat. The heat treatment furnace can also comprise several cameras.

In a technically advantageous embodiment of the heat treatment furnace, the electronic camera is arranged such that the dental object can be recorded laterally or the dental objects can be recorded laterally. This provides the technical advantage, for example, that the height of the dental object can be determined with high accuracy.

In another technically advantageous embodiment of the heat treatment furnace, the electronic camera is an RGB camera, a black-and-white camera or an infrared camera. This provides the technical advantage, for example, that particularly suitable cameras are used to generate the image data set.

In another technically advantageous embodiment of the heat treatment furnace, the electronic camera is arranged statically.

This provides the technical advantage, for example, that a simple design of the heat treatment furnace is achieved.

In another technically advantageous embodiment of the heat treatment furnace, the camera is arranged in a movable furnace head and/or the camera is rotatably arranged on the furnace head. Another possibility is that the camera can rotate on the furnace head or that the camera position is variable at a certain height. This provides the technical advantage, for example, that the dental object can be easily measured from different positions.

In another technically advantageous embodiment of the heat treatment furnace, the heat treatment furnace comprises an infrared lamp arranged to generate a heat curtain behind the dental object. This provides the technical advantage, for example, that the dental objects remain cooler than the background, allowing the infrared camera to see the dental objects with high sharpness.

In another technically advantageous embodiment of the heat treatment furnace, the heat treatment furnace comprises a position detection device for detecting a position of the furnace head. This provides the technical advantage, for example, that the image section can be changed by positioning the camera on the movable furnace head.

In another technically advantageous embodiment of the heat treatment furnace, the position detection device is configured to determine an opening angle of the furnace head. This provides the technical advantage, for example, that the height of the dental object can be calculated with high accuracy.

In another technically advantageous embodiment of the heat treatment furnace, the heat treatment furnace comprises a light source for illuminating the dental object. This provides the technical advantage, for example, that the image data set can be generated with a high image quality.

In another technically advantageous embodiment of the heat treatment furnace, the evaluation device is configured to determine a volume, a mass, a material and/or a size of the dental object on the basis of the image data set. This provides the technical advantage, for example, that a complete geometry measurement of the dental object can be carried out in the dental heat treatment furnace.

In another technically advantageous embodiment of the heat treatment furnace, the heat treatment furnace comprises a grid with lines for determining the height of the dental object. This provides the technical advantage, for example, that the height, zone and position of the dental object can be determined with high accuracy using the defined grid.

In another technically advantageous embodiment of the heat treatment furnace, the evaluation device is configured to integrate a virtual grid into the image data set. This provides the technical advantage, for example, that the dental object can be measured with different grids.

According to a second aspect, this technical task is solved by a method for determining a height of a dental object in a heat treatment furnace, comprising the steps of generating an image data set of the dental object within a firing chamber with an electronic camera; and determining a height and/or geometric dimension of the dental object on the basis of the image data set. The method achieves the same technical advantages as the heat treatment furnace.

In a technically advantageous embodiment of the method, an opening angle of a furnace head in which the camera is arranged is detected or a grid of the heat treatment furnace is detected. This also provides the technical advantage, for example, that the height of the dental object can be calculated with high accuracy.

In another technically advantageous embodiment of the method, the dental object is illuminated by a light source. This also provides the technical advantage, for example, that the image data set can be generated with a high image quality.

### BRIEF DESCRIPTION OF THE DRAWINGS

Exemplary embodiments of the invention are shown in the drawings and are described in more detail below, in which:

FIG. 1 shows a schematic view of a heat treatment furnace for a dental object;

FIG. 2 shows another schematic view of a heat treatment furnace for a dental object;

FIG. 3 shows a schematic view of method steps in the geometry measurement of dental objects; and

FIG. 4 shows a block diagram of a method for determining a height of a dental object in a heat treatment furnace.

### DETAILED DESCRIPTION

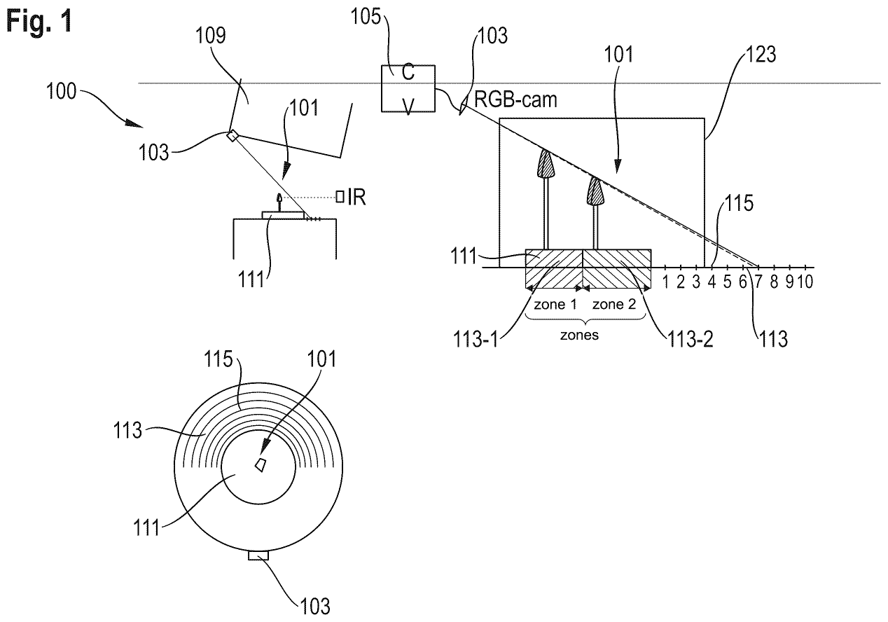

FIG. 1 shows a schematic view of a heat treatment furnace 100 for a dental object 101. The heat treatment furnace 100 comprises an electronic camera 103 for generating a digital image data set 107 of the dental object 101 within a firing chamber 123. The dental object 101 for heat treatment is, for example, a crown, a bridge, a veneer, an abutment, an inlay, an onlay, a splint or a partial or full prosthesis. The dental object 101 is arranged within the heat treatment furnace 100 in the firing chamber 123 and heated for heat treatment, such as when firing or tempering the dental object 101. For this purpose, the heat treatment furnace 100 comprises an electrical heating device which heats the dental object 101 in the firing chamber 123. Here, the temperature can be set by a user.

The dental object 101 is arranged on a firing surface 111 as a firing tray, which is formed by a silicon carbide disk, a silicon nitride firing tray or a honeycomb tray. The electronic camera 103 is arranged diagonally above the dental object 101 inside a hinged furnace head 109.

An evaluation device 105 is used to determine a height of the dental object 101 on the basis of the image data set 107. For this purpose, the evaluation device 105 comprises a processor which can be used to process and analyze the image data set and a digital memory in which the image data set and programs are stored.

The processor may be a hardware system, mechanism or component that processes data, signals or other information. Further, the processor may comprise a system having a central processing unit, several processing units, dedicated circuitry to achieve functionality, or other systems.

Processing or analysis by the processor is not limited to a spatial location or time. For example, the processor can perform its functions in real time, offline or in a so-called “batch mode”.

Several processors can also be provided. Parts of the processing or analysis can then be carried out at different times and at different locations by different or the same processors.

Exemplary computer chips that can be used as digital memory can be EEPROM chips (Electrically Erasable Programmable Read-Only Memory). For processing or analyzing an image data set stored on a digital memory by the processors, programs can be used which are also stored on a digital memory. The processors execute suitable instructions or programs, which may be on a non-volatile computer-readable medium, on hardware circuitry, or any combination thereof. The instructions may also be translated by one or more server machines.

For processing or analyzing the image data set by the processors, control logic may also be implemented in software, hardware or a combination of both. The control logic may be stored in an information storage medium, such as a computer readable medium, as a plurality of instructions. Such instructions are designed to instruct an information processing device to perform a sequence of operations.

By means of the camera 103, the dental object 101 on the firing surface 111 can be divided into several zones 113-1 and 113-2, such as a front and a rear zone. In general, the number of zones is arbitrary. The division into zones 113-1 and 113-2 is done by transforming the view of the dental object 101 in a top view. For this purpose, the camera 103 is calibrated in the position and the field of view, which are recorded at fixed points as input parameters and which initiate the transformation.

The variable position or height of the camera 103 and the distance of the camera 103 to the center of the firing surface 111 are known. This means that the field of view and the viewing direction of the camera 103 to the dental object 101 are also known. Since the position and height of the camera 103 is known, the height of the dental object 101 can be calculated from the image data set.

The dental object 101 imaged by the camera 103 covers or touches a zone 113 behind the dental object 101. This zone 113 comprises, for example, a grid or lines 115 that are arranged at regular intervals on the firing surface. The grid or lines 115 can also be mapped as a virtual overlay over the camera image and integrated into the image data set. This virtual grid or the lines 115 are generated by an image processing algorithm and superimposed over the image of the dental object 101 of the camera 103 to determine the height of the dental object 101.

The grid or lines 115 can be used as a ruler for the furnace geometry to determine the height of the dental object 101. The image processing algorithm can determine the height, size and orientation of the dental object 101 using the camera 103 as the imaging sensor and the predetermined grid.

The image processing algorithm can also be used to determine other properties of the dental object 101 and convert them into acoustic or visual operating signals for an operator. Depending on where the dental object 100 is located on the firing surface 111 and which lines of the grid 115 are touched by the dental object 101 on the image plane, the height of the dental object 101 can be determined.

The furnace head 109 may comprise an infrared lamp that shines down on the firing surface for a short time and generates a heat curtain behind the dental object 101. This keeps the dental object 101 slightly cooler for a period of time. An infrared camera 103 can detect the dental object 101 with sharp contours and temporarily store the image data set obtained in this way for further steps.

The heat treatment furnace 100 achieves good exposure of the dental objects 101 and rapid determination of the object heights. Better firing results are achieved by better adjustment of the working area for the infrared camera. In addition, firing trays that are too high can be determined so that a signal can be output if the dental objects 101 are too high or too small for the heat treatment furnace 100. Therefore, the dental objects 101 can be completely detected by the infrared camera and optimum results can be achieved.

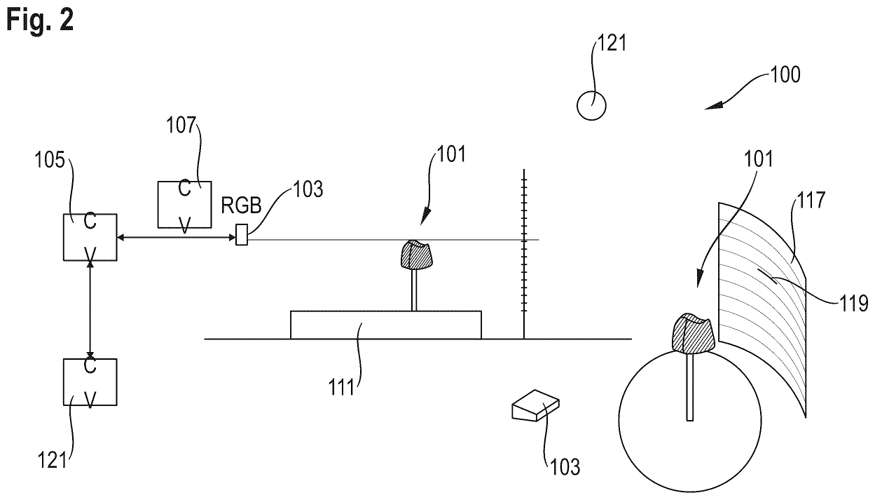

FIG. 2 shows another schematic view of the heat treatment furnace 100 for the dental object 101. The height of the dental object 101 is determined by the lower electronic camera 103. In the process, a virtual grid 115 is placed over the recorded image. The dental object 101 is arranged behind or in front of a wall 117 with lines 115 at certain intervals. The height of the dental object 101 is determined by the known geometry of the heat treatment furnace 100.

In unfavorable lighting conditions, an LED light array or an LED lamp is switched on around the camera 103 as a light source 121. By switching on an LED flash as a light source 121, additional shadows of the dental object 101 can be analyzed so that the height of the dental object 101 can be determined on the basis of this information. For example, a length of a shadow can be converted into a height of the dental object 101.

The heat treatment furnace 100 may comprise a position detection device 119 for detecting a position of the furnace head 107. For this purpose, the position detection device 119 can, for example, detect an opening angle of the furnace head 109. The opening angle can be transmitted as a digital value to the evaluation device 105. The evaluation device 105 can then calculate the position of the electronic camera 103, which is arranged in the furnace head 109, on the basis of the opening angle.

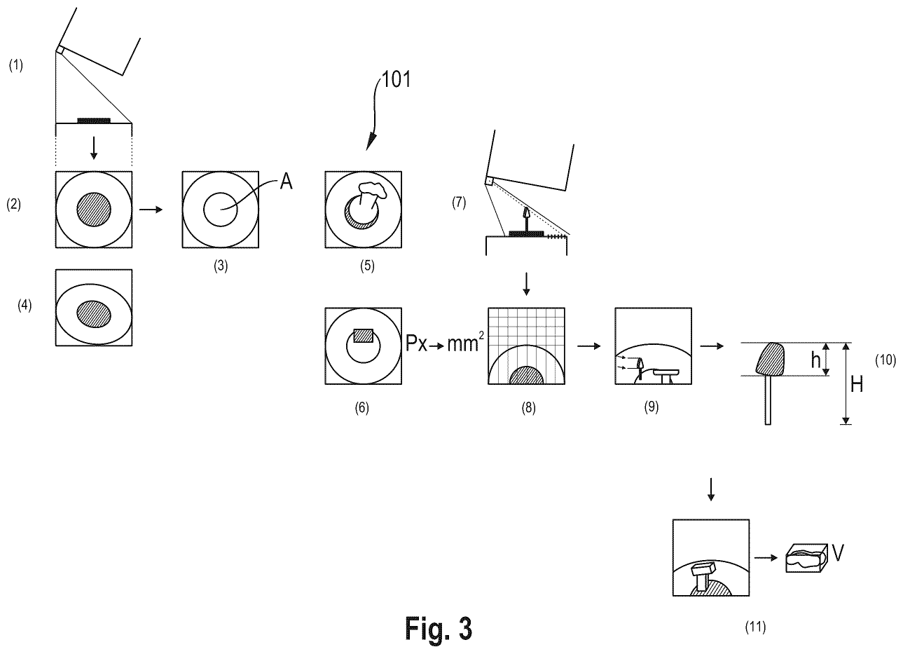

FIG. 3 shows a schematic view of method steps in the geometry measurement of the dental object 101. By positioning the camera 103 on the furnace head 109, it is possible to change the image section. At the highest position of the camera 103, i.e. the maximum opening angle of the furnace head 109, a good top view of the dental object 101 is obtained (1).

This top view makes it possible to recognize uniform shapes, such as a circular or square white insulating material or the circular black disc of the firing surface 111 (4). Using the image processing algorithm, the silicon carbide disc and the insulating material can be digitally separated and viewed individually, such as through digital color filters (3).

After digital separation, an edge detection algorithm can be used to detect the outline of the dental object 101, which then serves as a reference point for further calculations in the following steps. The actual circular dental object 101, the silicon carbide disk or the firing tray 111 is slightly distorted by the camera 103, which is positioned diagonally at the top, so that ellipses are created (4). These ellipses are transformed into circles by means of perspective transformation of the image (2).

As a result, the silicon carbide disk and the dental object 101 arranged thereon are displayed correctly. By stacking several dental objects 101 vertically, they are slightly distorted by the transformation (5). However, if the camera 103 is positioned high, the distortion error is negligible.

Since the area of the silicon carbide disk is known, the pixels can be converted into an area (mm²) (6). The number of pixels in the image data set 107 depends on the camera 103 and the image section being viewed. This is determined individually using image processing algorithms.

For example, the resolution of the image data set 107 of the camera 103 is set to a size of 400×400 pixels. This definition makes it possible to calculate the real size of the dental object 101 from the area of the detected dental object 101 in the image data set 107. An image processing algorithm automatically determines the area of recognized outlines of the dental object 101 and returns this area in the number of pixels. Since a predetermined area can be assigned to each pixel, a total area of the dental object 101 can be determined.

In addition, a different, more frontal image of the dental object 101 and the firing surface can be generated by lowering the furnace head 109 (7). A virtual grid placed over the image can be used to determine which line of the grid is touched by the arranged dental object 101 in the image data set 101 (8). Since the grid is geometrically precisely matched to the heat treatment furnace 100 and divided into zones, the height of the dental object 101 including the pins can be determined (9) and (10).

Using the information about the area from above and the height from the side, a volume (cube) of the dental object 101 can be calculated (11). The mass can be calculated using the information about the material of the dental object 101, which is obtained, for example, by a trained and self-learning algorithm (machine learning algorithm).

When the furnace head 107 is fully open, the dental object 101 can be recognized and its area calculated from above. If the furnace head 107 is moved to half position so that the lighting conditions are still good, the height of the dental object 101 can also be detected from the side.

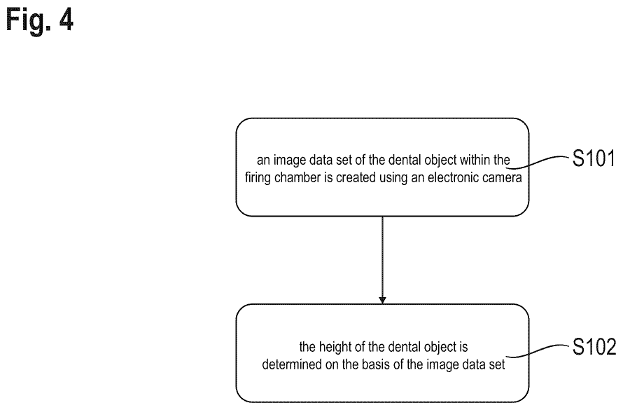

FIG. 4 shows a block diagram of a method for determining the height of the dental object 101 in the heat treatment furnace 100. In step S101, the image data set 107 of the dental object 101 within the firing chamber 123 is created using an electronic camera 103. In step S102, the height of the dental object 101 is determined on the basis of the image data set 107.

The height information of the dental object 101 can be used to create a more precise profile of the individual properties of the dental object, such as a volume, mass, material and size, using further digital image processing algorithms. The height is used here as additional information to make the assignment of the dental object 101 to different patients more reliable and to track it across further processing steps. The object information can also be used to optimize a temperature profile of the dental object 101.

The detected height of the dental object 101 can also be used to determine whether several trays have been stacked. Stacked trays bring more mass into the firing chamber 123 of the heat treatment furnace 100 and change thermal management accordingly. In addition, the dental object 101 can protrude beyond the image captured by the infrared camera and thus no longer be captured by the infrared camera.

Information on the size and height of the dental object can be used to determine the correct positioning of the element for automatic temperature calibration. The element for automatic temperature calibration is used for calibration and can be positioned and inserted correctly.

If, for example, it is detected that the element for automatic temperature calibration is positioned too high, a warning can be issued and the element for automatic temperature calibration can be inserted as far as it will go.

All of the features explained and shown in connection with individual embodiments of the invention can be provided in different combinations in the subject matter according to the invention in order to simultaneously realize their advantageous effects.

All method steps can be implemented by devices that are suitable for executing the respective method step. All functions performed by the features of the subject matter can be a method step of a method.

The scope of protection of the present invention is given by the claims and is not limited by the features explained in the description or shown in the figures.

### REFERENCE LIST

100 Heat treatment furnace
101 Dental object
103 Electronic camera
105 Evaluation device
107 Image data set
109 Furnace head
111 Firing surface
113 Zone
115 Grid
117 Wall
119 Position detection device
121 Light source
123 Firing chamber

1. A heat treatment furnace for a dental object, comprising:
an electronic camera for generating an image data set of the dental object within a firing chamber; and
an evaluation device for determining a height and/or geometric dimension of the dental object based on the image data set.

2. The heat treatment furnace according to claim 1,
wherein the electronic camera is arranged such that the dental object can be recorded laterally or dental objects can be recorded laterally.

3. The heat treatment furnace according to claim 1,
wherein the electronic camera is an RGB camera, a black-and-white camera or an infrared camera.

4. The heat treatment furnace according to claim 1,
wherein the electronic camera is arranged statically.

5. The heat treatment furnace according to claim 1,
wherein the electronic camera is arranged in a movable furnace head and/or the camera is rotatably arranged on the furnace head.

6. The heat treatment furnace according to claim 5,
wherein the heat treatment furnace comprises an infrared lamp arranged to generate a heat curtain behind the dental object.

7. The heat treatment furnace according to claim 5,
wherein the heat treatment furnace comprises a position detection device for detecting a position of the furnace head.

8. The heat treatment furnace according to claim 7,
wherein the position detection device is configured to determine an opening angle of the furnace head.

9. The heat treatment furnace according to claim 1,
wherein the heat treatment furnace comprises a light source for illuminating the dental object.

10. The heat treatment furnace according to claim 1,
wherein the evaluation device is configured to determine a volume, a mass, a material and/or a size of the dental object on the basis of the image data set.

11. The heat treatment furnace according to claim 1,
wherein the heat treatment furnace comprises a grid with lines for determining the height of the dental object.

12. The heat treatment furnace according to claim 1,
wherein the evaluation device is configured to integrate a virtual grid into the image data set.

13. A method for determining a height of a dental object in a heat treatment furnace, comprising
generating an image data set of the dental object within a firing chamber with an electronic camera; and
determining a height and/or geometric dimension of the dental object on the basis of the image data set.

14. The method according to claim 13,
wherein an opening angle of a furnace head in which the camera is arranged is detected or a grid of the heat treatment furnace is detected.

15. The method according to claim 13,
wherein the dental object is illuminated by a light source.
